(19) United States
(12) Patent Application Publication
(10) Pub. No.: US 2022/0036449 A1
(43) Pub. Date: Feb. 3, 2022

(54) Financial Concierge Service

(71) Applicant: Wells Fargo Bank, N.A., San Francisco, CA (US)

(72) Inventors: Wayne Barakat, Novato, CA (US); Pankaj Parekh, San Francisco, CA (US); Kristine Ing Kushner, Orinda, CA (US); Marria Rhodriquez, San Francisco, CA (US); Laura M. Fontana, San Francisco, CA (US)

(21) Appl. No.: 15/354,478

(22) Filed: Nov. 17, 2016

(51) Int. Cl. G06Q 40/00

(52) U.S. Cl. CPC G06Q 40/00

(57) ABSTRACT

A method implemented on a first electronic computing device for providing a financial concierge service to an individual includes monitoring a behavior of the individual. First information is obtained regarding a current activity of the individual. Second information is obtained regarding an emotional state of the individual. Third information is obtained regarding a location of the individual. Fourth information is obtained regarding a financial health of the individual. Fifth information is obtained regarding past financial transactions for the individual. The first, second, third, fourth and fifth information is used to determine a trigger point for the financial concierge service for the individual. When a determination is made that the trigger point has been reached, the financial concierge service for the individual is activated on a second electronic computing device.

### BACKGROUND

A financial institution can help an individual with financial tasks such as budgeting, buying and selling a home, financial planning, investments, inventorying assets and estate planning. The financial institution can also help keep track of important dates and other personal financial tasks.

The financial institution can sometimes provide a dedicated resource for an individual to turn to for help with the financial tasks. In some cases, the dedicated resource can be a personal banker to whom the individual can turn to for financial assistance. In other cases, particularly for high net worth clients, the dedicated resource can be a financial concierge service.

### SUMMARY

Embodiments of the disclosure are directed to a method implemented on a first electronic computing device for providing a financial concierge service to an individual, the method comprising: monitoring a behavior of the individual comprising obtaining first information regarding a current activity of the individual and obtaining second information regarding an emotional state of the individual; obtaining third information regarding a location of the individual; obtaining fourth information regarding a financial health of the individual; obtaining fifth information regarding past financial transactions for the individual; using the first, second, third, fourth and fifth information, determining a trigger point for the financial concierge service for the individual; and when a determination is made that the trigger point has been reached, activating the financial concierge service for the individual on a second electronic computing device.

In another aspect an electronic computing device comprises: a processing unit; and system memory, the system memory including instructions which, when executed by the processing unit, cause the electronic computing device to: monitor a behavior of the individual comprising obtaining first information regarding a location of the individual, second information regarding obtaining a current activity of the individual and obtaining third information regarding an emotional state of the individual; obtain fourth information regarding financial transactions for the individual; based on the first information and the second information determine a context of the current activity; based on the context of the current activity, the emotional state of the individual and the financial transactions of the individual, determine, in relation to the current activity, whether the individual is likely to make an undesirable financial decision; and when a determination is made that the individual is likely to make an undesirable financial decision, activate a financial concierge service for the individual on a second electronic computing device.

In yet another aspect, an electronic computing device comprises: a processing unit; and system memory, the system memory including instructions which, when executed by the processing unit, cause the electronic computing device to: monitor a behavior of the individual comprising obtaining first information regarding a current activity of the individual and obtaining second information regarding an emotional state of the individual; obtain third information regarding a location of the individual; obtain fourth information regarding past financial transactions for the individual; based on the first information, the second information, the third information and the fourth information, determine a context of the current activity; obtain fifth information regarding a financial health of the individual; based on the context of the current activity and the fifth information: determine a first threshold for a first financial concierge service for the individual, the first financial concierge service comprising a virtual assistant; and determine a second threshold for a second financial concierge service for the individual, the second financial concierge service including an interaction with a human; determine based on the context of the current activity and the fifth information whether the first threshold or the second threshold has been reached; when a determination is made that the first threshold has been reached but the second threshold has not been reached, activate the first financial concierge service for the individual on a second electronic computing device; and when a determination is made that the second threshold has been reached, activate the second financial concierge service on the second electronic computing device.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system that supports a financial concierge service.

FIG. 2 show example modules of the personal financial assistant module of FIG. 1.

FIG. 3 shows a method for obtaining preliminary information for the financial concierge service.

FIG. 4 shows a method for creating a trigger point for activating the financial concierge service.

FIG. 5 shows example physical components of the financial institution server computer of FIG. 1.

### DETAILED DESCRIPTION

The present disclosure is directed to systems and methods for providing a financial concierge service to individuals who are customers of a financial institution. The financial concierge service can provide personalized financial assistance to a customer. The financial concierge service can comprise a personal assistant that can be activated on an electronic computing device of the customer, such as a smartphone. The personal assistant can be a virtual assistant that can provide a virtual interaction on the smartphone with the financial institution. The virtual assistant can act as a listener and as a persistent financial advisor to the customer. Alternatively, the personal assistant can comprise an interactive session with an actual human. In this disclosure, the terms individual and customer are used interchangeably.

The financial institution can leverage information already known about the customer with data from a current activity of the customer to determine when to activate the financial concierge service. The information already known about the customer can be obtained from a profile of the customer, from financial account data for the customer, financial transaction data for the customer and from other sources. For example, the financial institution is likely to already know certain personal information regarding the customer including employment information, family information, mortgage information, personal loan information, bill pay information, investment information and information from financial transactions. The information from the current activity of the customer can include a location of the customer, an actual activity in which the customer is engaged and an emotional state of the customer.

The financial institution can determine from the current activity of the customer and from the information already know about the customer when the customer is in a situation than could benefit from the financial concierge service, such as that offered by the virtual assistant. For example, if the financial institution is aware that the customer is trying to maintain a budget, that the customer is currently in a certain retail store and that the customer has a history of overspending in this retail store, the financial institution can activate the virtual assistant. A picture of a human can be displayed on the customer's smartphone along with a message. The message be displayed on the customer's smartphone and can also be an audible message. The message can provide a friendly reminder to the customer regarding the need to maintain the budget and the susceptibility of the customer of overspending in the retail store. The virtual assistant can also present pertinent questions of the customer such as “do you really want to purchase this item” or “do you really want to pay this much for this item” or “do you really want to be in this retail store at this time” or other similar questions based on a knowledge of the customer's current location and financial health status.

As another example, the financial institution can determine from a location of the customer that the customer is walking in an area where there is an open house for a home. The financial institution also knows that the customer is in a market for a home in the general area of the open house. The financial institution can use this information to activate the virtual assistant on the customer's smartphone. The virtual assistant can then inform the customer of the open house. However, rather than simply providing a notification or an alert to the customer on the customer's smartphone, the virtual assistant, including a combination of the photo of a human, the ability to provide audible messages and the ability to interact with the customer, may make it more likely that the customer will pay attention to the information regarding the open house and actually attend the open house.

As yet another example, the financial institution can determine from a location of the customer that the customer is in a gambling casino. The financial institution knows from previous electronic transactions that the customer has a history of gambling at the casino. The financial institution also receives a current transaction regarding the customer that the customer has put a credit card on an active credit payment status to gamble at the casino. The financial institution also knows from financial account information for the customer that the customer has a high amount of credit card debt and that a financial health status of the customer is not good. In addition, the financial institution receives physiological information from a fitness tracker of the customer that the customer is in an excited state with a relatively high heart rate and an indication of rapid movement, such as the customer jumping up and down. Using all this information, the financial institution can determine that the customer is likely to make a bad financial decision and that a financial intervention may be warranted. However, because of the potential seriousness of this situation, the financial institution can determine when activating the financial concierge service to use an actual human, rather than a virtual assistant. In this case, the financial concierge service can be implemented via a video session with the customer's smartphone, such as a Skype or Facetime video session. An actual employee of the financial institution, for example a banker, can talk to the customer via the video session, talk with the customer, try to calm the customer down and try to talk the customer into leaving the casino before the customer makes an inappropriate financial decision. Alternatively, the banker can telephone the customer.

The determination as to whether to activate the financial concierge service can be based on an analysis of a plurality of inputs regarding the customer. The inputs can include intents and preferences of the customer, a status of the customer's financial health at a current stage in the customer's life and current inputs from Internet of Things (TOT) devices such as a personal fitness tracker and a GPS (global positioning system) device that provide information as to what the customer is doing and where the customer is currently located.

Regarding the inputs, the customer can opt in to authorize the sharing of specific personal and financial information with the financial institution. For example, the customer can fill out a customer profile and indicate current and future interests and goals. For example, the customer can indicate a preference of wanting to live a fiscally sound life or the customer can indicate a preference to travel, even if travelling means having a lower savings rate. The customer can also indicate what personal and financial information the customer is willing to share with the financial institution. For example, the customer can opt to share information from the customer's fitness tracker and to share information regarding financial transactions, but not to share any other information that the financial institution does not already have regarding the customer.

The systems and methods disclosed herein are directed to a computer technology that can automatically determine when to activate a financial concierge service for an individual who is a customer of a financial institution. The determination as to whether to activate the financial concierge service can be based on a plurality of inputs from the user including a context of a current activity for the individual and a detected emotional state of the individual. The emotional state of the individual can be obtained from one or more physiological devices physically located on or near the individual than can provide physiological data regarding the emotional state of the individual. Determining when to provide an intervention, such as via the financial concierge service, that can help the individual and basing an activation of the financial concierge service on a combination of a context of the current activity and the emotional state of the individual can efficiently and automatically provide a service that can solve a computing problem regarding automatic personal intervention.

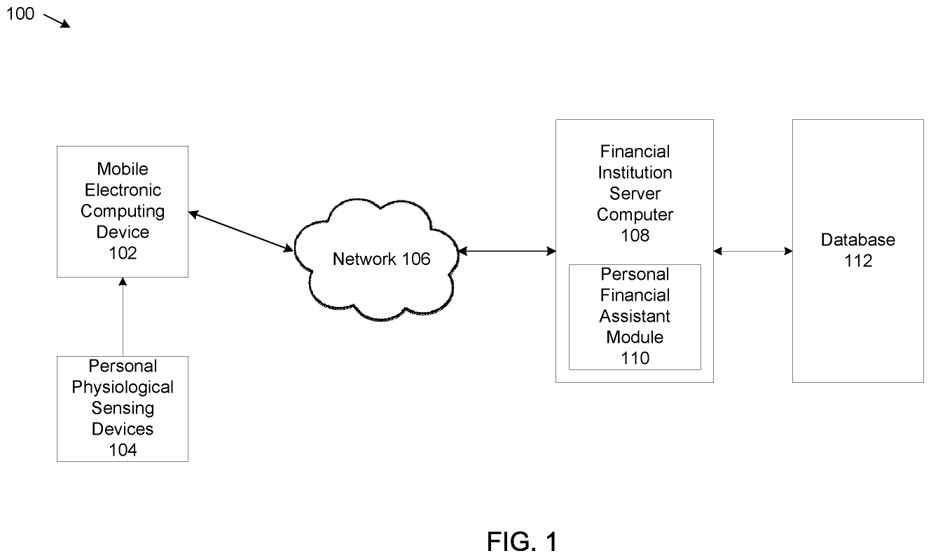

FIG. 1 shows an example system 100 that can support a financial concierge service for an individual, such as a customer of a financial institution. The system 100 includes a mobile electronic computing device 102, personal physiological sensing devices 104, a network 106, a financial institution server computer 108 and a database 112. The financial institution server computer 108 includes a personal financial assistant module 110. More, fewer or different components are possible.

The example mobile electronic computing device 102 is an electronic computing device such as a smartphone, a laptop computer or a tablet computer. The mobile electronic computing device 102 can include a software application for the financial institution, such that the customer can login to the financial institution server computer 108 from the mobile electronic computing device 102. The mobile electronic computing device 102 can also include a GPS application that can determine a current location of the customer. In this disclosure, the mobile electronic computing device is discussed with respect to a smartphone.

The example personal physiological sensing devices 104 include one or more physiological sensing devices that can sense physiological parameters of the customer. For example, the personal physiological sensing devices 104 can include a personal fitness tracker that can measure steps, heart rate and other physiological parameters of the individual. The personal physiological sensing devices 104 can have a wireless connection to the smartphone and send data regarding the physiological parameters to the smartphone. In turn, the smartphone can make the data regarding the physiological parameters available to the financial institution server computer 108 via network 106.

The example network 106 is a computer network such as the Internet. Mobile electronic computing device 102 can wirelessly connect to or otherwise access financial institution server computer 108 via network 106.

The example financial institution server computer 108 is a server computer at a financial institution such as a bank. Individuals can access financial institution server computer 108 from mobile electronic computing device 102 via network 106. Financial institution server computer 108 can comprise more than one server computers.

The example personal financial assistant module 110 implements a financial concierge service for customers of the financial institution. As discussed in more detail later herein, the personal financial assistant module 110 can monitor current activity of the customers and based on a context of the current activity and other information including a financial health status of a customer, a personal profile of the customer and a current emotional state of the customer can activate a personal assistant on the customer's smartphone. As discussed earlier herein, the personal assistant can be a virtual assistant or the personal assistant can comprise an interactive session with human, such as a personal banker.

The example database 112 is an electronic database that can be accessed from financial institution server computer 108. The database 112 can store personal and financial records of customers of the financial institution.

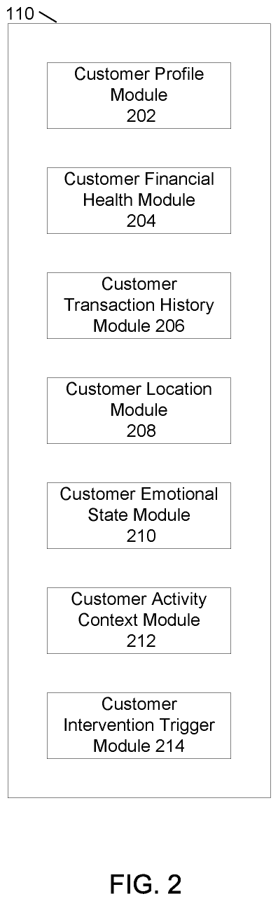

FIG. 2 shows example modules of personal financial assistant module 110. The example modules include a customer profile module 202, a customer financial health module 204, a customer transaction history module 206, a customer location module 208, a customer emotional state module 210, a customer activity context module 212 and a customer intervention trigger module 214. More, fewer or different modules are possible.

The example customer profile module 202 obtains a personal profile for customers of the financial institution. The personal profile can include information regarding the name, address, age and employment information of a customer and of members of the customer's family, other information about the customer including the customer's social security number, financial accounts at the financial institution, telephone number(s), email address(s) and information regarding personal interests, goals and preferences for the customer. The preferences can include an indication of whether the customer wants to opt-in to the financial concierge service and if so, what personal information the customer wants to make available. In an example implementation, the customer needs to opt-in in order to activate the financial concierge service. Information that the customer can decide to make available can include such items as financial transactions and data from physiological tracking devices.

The customer profile module 202 can also obtain and store a picture of the customer that can be used to authenticate the customer at the financial institution server computer 108. For example, the customer can have the picture taken at a branch office of a bank. The customer can also take his/her own photo (selfie) when opening an account at the bank. The customer profile module 202 can also include budgeting information for the customer for a variety of spending categories.

The example customer financial health module 204 can analyze information regarding the customer's finances and can provide a status of the customer's financial health. In some implementations, the status of the customer's financial health can be represented by a score, for example from 1 to 100, where 100 can indicate a highest degree of customer financial health. In other implementations, the status of the customer's financial health can be represented by a category, for example excellent, very good, good, fair and poor.

The customer financial health module 204 can determine the status of the customer's financial health by analyzing such things as known customer assets, known customer liabilities and a credit score for the customer. The known customer assets can include the value of one or more financial accounts at the financial institution, customer investments known to the financial institution, real estate owned by the customer, including the customer's home, vehicles own by the customer and other assets. The known customer liabilities can include known customer personal debt, including a mortgage on the customer's home, credit card debt and investment debt. The credit score can be obtained from one of the three credit bureaus—Experian, Equifax and TransUnion.

The example customer transaction history module 206 can analyze customer transactions at the financial institution when opt-in permission for such analyzing is provided by the customer. The customer transaction history module 206 can categorize the transactions to obtain a profile of customer behavior. The customer transaction history module 206 can also evaluate dollar values of the customer transactions to determine whether any are excessive and exceed guidelines based on a customer budget. For example, the customer transaction history module 206 can determine that the customer consistently spends more than a budgeted amount for such categories as eating out, beverages at Starbucks, or making purchases at certain retail stores. The customer transaction history module 206 can create alerts that the customer intervention trigger module 214 can use to determine whether to activate the financial concierge service. For example, an alert can be generated when a determination is made that the customer is at a Starbucks location and the customer has already spent more than a budgeted amount at Starbucks for a budget period such as a week or a month.

The example customer location module 208 implements a GPS location function for the smartphone. The GPS location function permits financial institution server computer 108 to continually track the location of the customer.

The example customer emotional state module 210 uses physiological sensing and other information to attempt to determine an emotional state of the customer. The physiological sensing can include sensors from devices such as a fitness tracker, an oxygen sensor or a blood pressure monitor. Other devices can be used. In some implementations, the customer emotional state module 210 can determine a numerical score corresponding to the emotional state. In other implementations, the customer emotional state module 210 can provide a description of the emotional state, such as excellent, very good, good, fair or poor. Other descriptions of the emotional state are possible. The customer emotional state module 210 can also monitor telephone conversations between the customer and the financial institution and make a judgment of the customer's emotional state from the telephone conversation. For example, if the customer speaks at a more rapid than normal speed, or speaks unusually loudly or cries or uses certain words that indicate anger or extreme anxiety, the customer emotional state module 210 can adjust a score or description of the customer's emotional state accordingly.

The example customer activity context module 212 determines a context of a customer activity based on a location of the customer, a customer profile, the emotional state of the customer and other factors. For example, if the customer is at a residential location and the customer profile indicates that the customer is interested in purchasing a home and the financial institution has information that there is an open house at that location and the customer emotional state module 210 indicates that the customer's heart rate is elevated, the customer activity context module 212 can determine that the customer is viewing a home for sale. As another example, if the customer is at a retail store and the financial institution has knowledge, based on the customer transaction history, that the customer likes to shop at the retail store, the customer activity context module 212 can determine that the customer is shopping at the retail store.

The example customer intervention trigger module 214 can determine, based on the customer profile, the customer financial health status, the customer transaction history, the customer activity context and the customer emotional state, whether to activate the financial concierge service on the customer's smartphone. In addition, the customer intervention trigger module 214 can decide whether to activate a virtual assistant or a human assistant. Based on a combination of the factors listed and in some cases other factors, the customer intervention trigger module 214 can calculate an intervention trigger score for the customer, for example a number from 1 to 100. The intervention trigger score can be compared against two thresholds, one threshold for virtual assistance and another threshold for human assistance. When the intervention trigger score is lower than both thresholds, a determination can be made that the financial concierge service does not need to be activated. When the intervention trigger score is higher than the threshold for virtual assistance but lower than the threshold for human assistance, a determination can be made that the financial concierge server should be activated using a virtual assistant. However, when the intervention trigger score is higher than the threshold for human assistance, a determination can be made that the financial concierge service should be activated using a human.

The calculation of the intervention trigger score can use weightings for the various factors mentioned above herein. Higher weightings can be given to the financial health status factor when the customer's financial health is determined to be in a critical area—for example a fair or a poor financial health status and to the customer's emotional state when the customer's emotional state is determined to be less than optimal—for example fair or poor. In addition, a higher weighting can be given to the financial health status factor when the customer activity context indicates that the customer is in a situation that may compromise the customer's financial health—such as gambling when the customer already has high gambling debt or being on the verge of purchasing an item in a certain product category when it is known that the customer is significantly over budget for that product category.

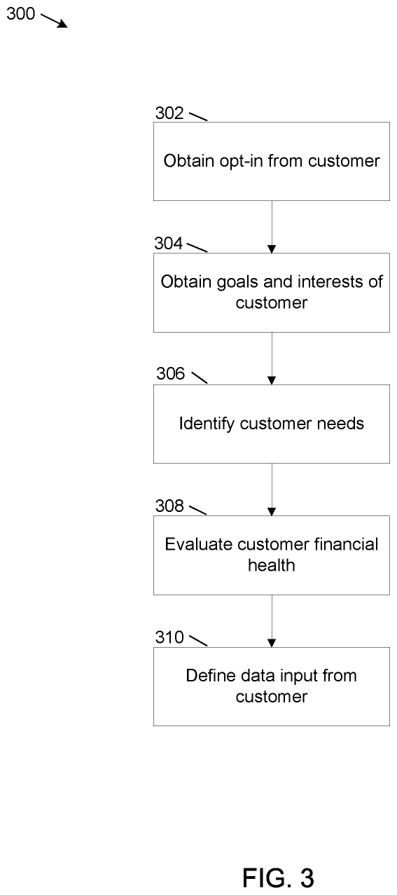

FIG. 3 shows a flowchart of an example method 300 for obtaining preliminary information regarding a financial concierge service for an individual who is a customer of a financial institution.

At operation 302, an opt-in is obtained from the customer for to participate in the financial concierge service. The opt-in implies that the customer agrees to make certain personal and physiological information available to the financial institution and to understand that the financial concierge service can be activated at any time based in part on the customer's current activity.

At operation 304 personal goals and interests of the customer are obtained. The personal goals and interests can be obtained in one or more ways, including a questionnaire that can be filled out by the customer, from an in-person meeting or telephone conversation between the customer and a representative of the financial institution, from a user interface on a website of the financial institution from a transaction history of the customer and from other sources.

At operation 306, customer needs are identified. The customer needs can be identified from the personal goals and interests of the customer, from the age and interests of the customer's family members, from the customer's employment history and current salary, from heuristics based on individuals with similar socio-economic backgrounds of the customer and from other sources.

At operation 308, the financial health of the customer is evaluated. The evaluation of the customer's financial health can include items such as the customer's current salary, the current salary of the customer's spouse and assets and liabilities of the customer. As discussed earlier herein, the evaluation of the customer's financial health can result in a numerical score, for example from 1 to 100, or a characterization such as excellent, very good, good, fair and poor.

At operation 310, data input from the customer is defined. The data input can be used to determine a current activity of the customer and a context of the current activity. The data input can include such items as a current GPS location of the customer, data from electronic transactions such as purchases made by the customer and payments made, such as bill pay and physiological data such as physical parameters from a physiological tracking device that can be worn by the customer. The data input used is authorized to be collect and used by the customer when the customer opts-in at operation 302.

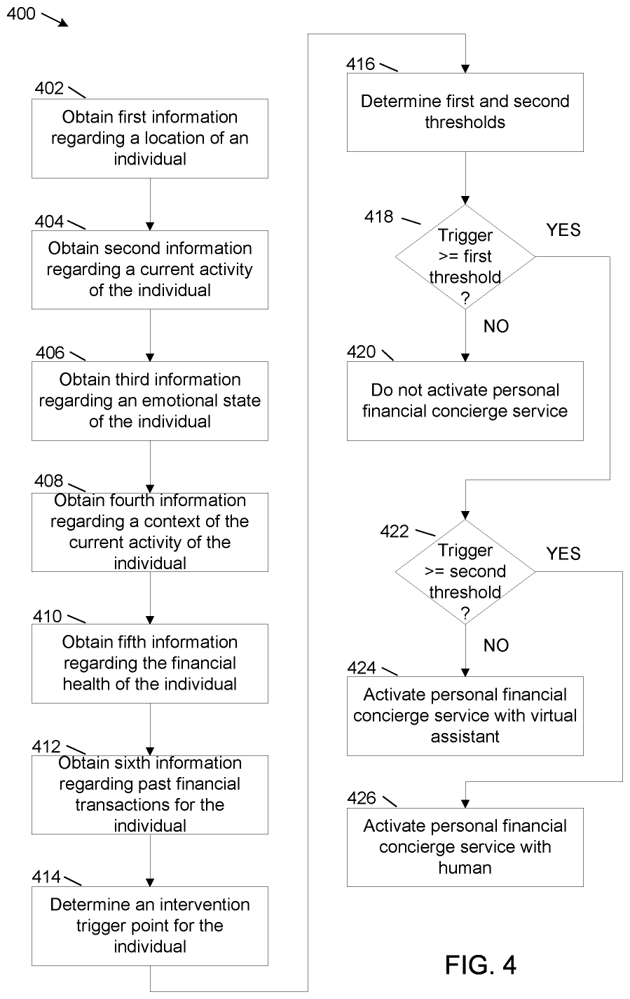

FIG. 4 shows a flowchart of an example method 400 for determining a trigger point on a server computer for activating a financial concierge service on a smartphone. The server computer is a server computer or a financial institution, for example financial institution server computer 108. The trigger point represents a point at which a determination is made that an intervention of the financial concierge service is needed to help an individual who is a user of the smart phone. The individual is a customer of the financial institution. For this example, a financial software application that supports the financial concierge service is installed on the smartphone.

At operation 402, first information regarding a current location of the individual is obtained at the server computer. The first information is obtained from a GPS software application on the smartphone. The smartphone sends the first information to the server computer.

At operation 404, second information regarding current activity of the individual is obtained at the server computer. The information regarding the current activity can be obtained from one or more sources including geolocation information for the individual, transaction data from the individual received at the server computer, sensing devices used or associated with the individual including a fitness tracker, patterns of past activity of the individual at the geolocation of the individual and other sources.

At operation 406, third information regarding an emotional state of the individual is obtained at the server computer. The information regarding the emotional state of the individual can be obtained from one or more sources including data from one or more sensing devices associated with the individual, from a telephone call with the individual, from personal contact with the individual, from current actions of the individual from which information regarding the emotional state of the user can be determined and from other sources. The one or more sensing devices can include a personal fitness tracker which can measure heart rate, steps taken and other physical parameters of the individual. Other sensing devices can include a speech processing device that can determine a rapidity, a volume and an anxiety level of the individual's speech and a heat sensing device that can determine the individual's body temperature and can also determine a stress level of the individual. Other sensing devices are possible.

At operation 408, fourth information is obtained regarding a context of the current activity of the individual. The context can be obtained from the location of the individual, the current activity of the individual, the emotional state of the individual and from information known about the individual by the financial institution. For example, if a determination is made that the individual is at a Starbuck's coffee shop and the individual has a history, based on past transactions of purchasing coffee at the Starbuck's coffee shop, the context of the current activity may be that the individual is about to make a purchase at the Starbuck's coffee shop. For this example, the emotional state of the individual may not be a factor in determining the context, but for other scenarios, for example if the individual is at a gambling casino or a car dealership, the emotional state of the individual can affect the context, such as the individual gambling or purchasing a car.

At operation 410, fifth information regarding a financial health of the individual is obtained at the server computer. The fifth information is obtained from financial information stored at or available to the financial institution including financial accounts, personal debt including a home mortgage and credit card debt, current salary, employment history, employment status of the individual's spouse, status of the individual's children, value of the individual's home, information from credit score bureaus and other information.

At operation 412, sixth information regarding past financial transactions of the individual is obtained at the server computer. The sixth information is obtained from financial transactions processed for the individual at the financial institution.

At operation 414, the first, second, third, fourth, fifth and sixth information is used to determine an intervention trigger point for the individual. The intervention trigger point is a point at which a determination is made that it could be helpful to provide a financial concierge service to the individual. The financial concierge service can be provided for several reasons. One reason could be that based on current data for the individual, it could be appropriate for the financial institution to provide one or more offers for products and services to the individual. This can include offers for credit cards, reward cards, loans, vacation trips, bonus points and other offers. Another reason could be that a determination is made based on current data for the individual that the individual is an a situation where the user may be diverging from personal goals such as keeping a budget or controlling spending for one or more products or services. A third reason could be that a determination is made based on current data for the individual that the individual is in a situation where the individual may make a serious financial mistake, such as gambling too much money or making an investment mistake. Other reasons are possible.

The financial institution can determine the intervention trigger point by evaluating the first, second, third, fourth, fifth and sixth information, and possibly other information and weighting one or more of the first, second, third, fourth, fifth and sixth information appropriately, as discussed earlier herein. A numerical intervention trigger score, corresponding to the intervention trigger point, can thereby be determined, for example a numerical score between 1 and 100.

At operation 416, first and second thresholds are determined. The first threshold corresponds to a value of the intervention trigger score at which a determination is made that a personal financial concierge service with a virtual assistant is warranted. The second threshold corresponds to a value of the intervention trigger score at which a determination is made that a financial concierge service with a human interaction is warranted. In some implementations, additional thresholds may be determined.

At operation 418, a determination is made as to whether the value of the intervention trigger score is greater than or equal to the first threshold.

When a determination is made at operation 418 that the value of the intervention trigger score is not greater than or equal to the first threshold, at operation 420, a determination is made not to activate the financial concierge service.

When a determination is made at operation 418 that the value of the intervention trigger score is greater than or equal to the first threshold, at operation 422, a determination is made as to whether the intervention trigger score is greater than the second threshold.

At operation 422, when a determination is made that the value of the intervention trigger score is not greater than or equal to the second threshold, at operation 424, a financial concierge service with a virtual assistant is activated.

At operation 422, when a determination is made that the value of the intervention trigger score is greater than or equal to the second threshold, at operation 426, a financial concierge service is a human in activated.

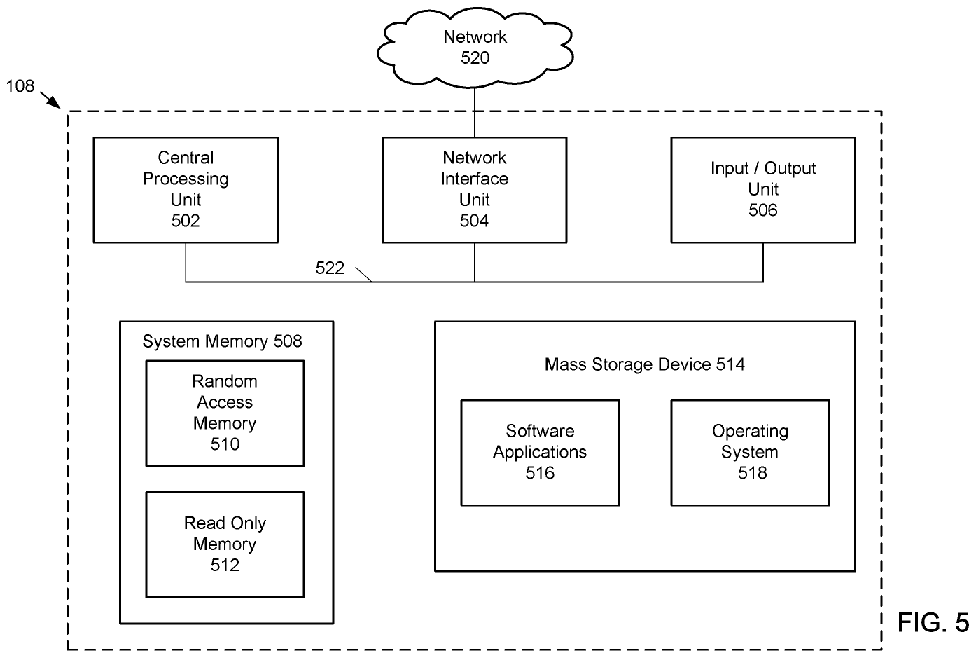

As illustrated in the example of FIG. 5, financial institution server computer 108 includes at least one central processing unit (“CPU”) 502, a system memory 508, and a system bus 522 that couples the system memory 508 to the CPU 502. The system memory 508 includes a random access memory (“RAM”) 510 and a read-only memory (“ROM”) 512. A basic input/output system that contains the basic routines that help to transfer information between elements within the financial institution server computer 108, such as during startup, is stored in the ROM 512. The financial institution server computer 108 further includes a mass storage device 514. The mass storage device 514 is able to store software instructions and data. Some or all of the components of the financial institution server computer 108 can also be included in mobile electronic computing device 102.

The mass storage device 514 is connected to the CPU 502 through a mass storage controller (not shown) connected to the system bus 522. The mass storage device 514 and its associated computer-readable data storage media provide non-volatile, non-transitory storage for the financial institution server computer 108. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the financial institution server computer 108.

According to various embodiments of the invention, the financial institution server computer 108 may operate in a networked environment using logical connections to remote network devices through the network 520, such as a wireless network, the Internet, or another type of network. The financial institution server computer 108 may connect to the network 520 through a network interface unit 504 connected to the system bus 522. It should be appreciated that the network interface unit 504 may also be utilized to connect to other types of networks and remote computing systems. The financial institution server computer 108 also includes an input/output controller 506 for receiving and processing input from a number of other devices, including a touch user interface display screen, or another type of input device. Similarly, the input/output controller 506 may provide output to a touch user interface display screen or other type of output device.

As mentioned briefly above, the mass storage device 514 and the RAM 510 of the financial institution server computer 108 can store software instructions and data. The software instructions include an operating system 518 suitable for controlling the operation of the financial institution server computer 108. The mass storage device 514 and/or the RAM 510 also store software instructions, that when executed by the CPU 502, cause the financial institution server computer 108 to provide the functionality of the financial institution server computer 108 discussed in this document. For example, the mass storage device 514 and/or the RAM 510 can store software instructions that, when executed by the CPU 502, cause the financial institution server computer 108 to display received data on the display screen of the financial institution server computer 108.

Although various embodiments are described herein, those of ordinary skill in the art will understand that many modifications may be made thereto within the scope of the present disclosure. Accordingly, it is not intended that the scope of the disclosure in any way be limited by the examples provided.

1. A method implemented on a first electronic computing device for providing a financial concierge service to an individual, the method comprising:
obtaining location information regarding a location of the individual, including:
using a global positioning satellite sensor to determine the location of the individual; and
correlating the location information to a particular activity associated with the location;
monitoring a behavior of the individual, comprising:
obtaining activity information regarding a current activity of the individual, including determining an activity context for the individual based upon the local information from the global positioning satellite sensor and the particular activity associated with the location;
obtaining emotional state information regarding an emotional state of the individual, the emotional state being determined using input from at least one physiological sensor associated with the individual, including monitoring speech from the individual by receiving speech data from a speech sensor, the speech data indicating a speed and a volume of the speech; and
determining a stress level for the individual based upon the activity context for the individual and the speech from the individual;
obtaining financial health information regarding a financial health of the individual;
obtaining financial transaction history information regarding past financial transactions for the individual;
using the activity information, the emotional state information, the location information, the financial health information, and the financial transaction history information, determining a trigger point for the financial concierge service for the individual, the trigger point being reached when a determination is made that the behavior will result in negative financial consequences for the individual, wherein:
the activity context of the individual and the emotional state of the individual have a higher weight in determining the trigger point than any of the location information, the financial health information, and the financial transaction history when the emotional state of the individual is determined to have crossed a threshold emotional state level; and
the financial health information and the financial transaction history information have a higher weight in determining the trigger point than any of the activity information, the emotional state information, and the location information when the financial health of the individual is determined to have crossed a threshold financial health level; and
when a determination is made that the trigger point has been reached, activating the financial concierge service for the individual on a second electronic computing device, including:
determining whether the trigger point exceeds a threshold for a human intervention;
when the trigger point exceeds the threshold for the human intervention, automatically providing an interaction with a human on the second electronic computing device; and
when the trigger point does not exceed the threshold for the human intervention, automatically initiating a virtual assistant on the second electronic computing device.

2-4. (canceled)

5. The method of claim 1, further comprising obtaining sixth information regarding physical parameters of the individual.

6. The method of claim 5, wherein the physical parameters include one or more of steps taken, pulse or heart rate and blood pressure.

7. The method of claim 5, further comprising obtaining the sixth information using a fitness tracker that is worn or carried by the individual.

8-10. (canceled)

11. The method of claim 1, further comprising, before monitoring the behavior of the individual and obtaining information regarding the emotional state of the individual, receiving an authorization from the individual.

12. The method of claim 1, further comprising receiving a directive from the individual as to which of the activity information, the emotional state information, the location information, the financial health information, and the financial transaction history information can be used by a financial institution associated with the first electronic computing device.

13. An electronic computing device comprising:
a processing unit; and
system memory, the system memory including instructions which, when executed by the processing unit, cause the electronic computing device to:
obtain location information regarding a location of the individual, including:
use a global positioning satellite sensor to determine the location of the individual;
correlate the location information to a particular activity associated with the location;
monitor a behavior of the individual comprising to:
obtain activity information regarding a current activity of the individual, including to determine an activity context for the individual based upon the local information from the global positioning satellite sensor and the particular activity associated with the location; and
obtain emotional state information regarding an emotional state of the individual, the emotional state being determined using input from at least one physiological sensor associated with the individual, including monitoring speech from the individual by receiving speech data from a speech sensor, the speech data indicating a speed and a volume of the speech; and;
determine a stress level for the individual based upon the activity context for the individual and the speech from the individual;
obtain financial health information regarding financial transactions for the individual;
obtain financial transaction history information regarding past financial transactions for the individual;
based on the activity information, the emotional state information, the location information, the financial health information, and the financial transaction history information, determine, in relation to the current activity, whether the individual is likely to make a financial decision that will result in negative financial consequences for the individual, wherein:
the activity context of the individual and the emotional state of the individual have a higher weight in determining the trigger point than any of the location information, the financial health information, and the financial transaction history when the emotional state of the individual is determined to be below a threshold emotional state level; and
the financial health information and the financial transaction history information have a higher weight in determining the trigger point than any of the activity information, the emotional state information, and the location information when the financial health of the individual is determined to be below a threshold financial health level; and
when a determination is made that the individual is likely to make the financial decision that will result in the negative financial consequences for the individual, activate a financial concierge service for the individual on a second electronic computing device, including to:
determine whether the trigger point exceeds a threshold for a human intervention;
when the trigger point exceeds the threshold for the human intervention, automatically provide an interaction with a human on the second electronic computing device; and
when the trigger point does not exceed the threshold for the human intervention, automatically initiate a virtual assistant on the second electronic computing device.

14. The electronic computing device of claim 13, further comprising:
using the activity information, the emotional state information, the location information, the financial health information, and the financial transaction history information to determine a trigger point for the financial concierge service for the individual;
when the trigger point is greater or equal than a first threshold but less than a second threshold, activate a virtual assistant for the financial concierge service; and
when the trigger point is greater or equal than a second threshold, provide an interaction with a human for the financial concierge service.

15. The electronic computing device of claim 13, wherein obtaining the emotional state information of the individual comprises evaluating physiological data from the individual.

16. The electronic computing device of claim 15, wherein the physiological data is obtained from one more physiological sensors that monitor physical parameters of the individual.

17. (canceled)

18. The electronic computing device of claim 13, further comprising: when a determination is made that a financial institution associated with the electronic computing device has information that can be helpful for the individual, activate the financial concierge service for the individual on the second electronic computing device.

19-20. (canceled)
